(19) United States
(12) Patent Application Publication
(10) Pub. No.: US 2015/0184807 A1
(43) Pub. Date: Jul. 2, 2015

(54) Universal Lamp Support

(71) Applicant: John Bryan Vincent, San Angelo, TX (US)

(72) Inventor: John Bryan Vincent, San Angelo, TX (US)

(21) Appl. No.: 14/582,944

(22) Filed: Dec. 24, 2014

Related U.S. Application Data
(60) Provisional application No. 61/920,791, filed on Dec. 26, 2013.

(51) Int. Cl. F21K 99/00; F21V 19/00

(52) U.S. Cl. CPC F21K 9/17; F21V 19/008; F21Y 2103/003

(57) ABSTRACT

An apparatus, manufacture and method of illumination support being a single structural element with light emitting diodes mounted on the external faces of the structural element. The necessary circuitry for the LEDs is embedded in a rigid or flexible substrate that is affixed to the external faces of the structural element. The two terminal ends of the structural element are designed to fit into the lamp sockets of an existing or new light fixture, which provides mechanical support for the structural element.

### PRIORITY

This application claims priority from a provisional application Ser. No. 61/920,791, filed on Dec. 26, 2013; hereby incorporated by reference in its entirety.

### DETAILED DESCRIPTION

Embodiments of the invention are directed to a single piece lamp support 1 (FIG. 1) for the replacement of florescent lamps 14 (FIG. 7), or other type of double contact lamps, with light emitting diodes (“LED”) to illuminate a light cabinet or other lighting applications. Installation of the invention is easy and requires no additional support brackets because the terminal ends 2a, 2b (FIG. 1) of the support element 1 (FIG. 1) are designed to fit directly into the existing light fixture 12 (FIG. 7) lamp sockets 9 (FIG. 7) and use these as the structural supports. The existing lamp sockets are used as structural supports but are eliminated as live circuits and instead the light emitting diodes are wired directly to the power source. The structural element can accommodate various types of light emitting diodes 6 (FIGS. 2 and 3). The single piece lamp support may be straight, bent, or curved to accommodate different light cabinet shapes as needed and will be referred to as the Structural Element, which is synonymous with lamp support element.

The configurations of LED mounting that work with the lamp support element include but are not limited to the following examples. The LED can be mounted onto a flexible or rigid substrate 5 (FIGS. 2 and 3) and the substrate may contain all the needed circuitry to deliver the appropriate power to the LED, as well as any other electronic components required to control the LED. When mounted on to a substrate with all the needed circuitry contained within the substrate; the substrate, inner circuitry, and LED is referred to, and defined as, a “LED String” 4 (FIGS. 2 and 4). A String may contain one or more LEDs. The LEDs can also be mounted onto multiple substrates. The multiple substrates can contain the circuitry required for powering the LED or controlling the LED, facilitate the connection between the LED String and the support element, and provide a weather and moisture barrier to protect the LED and circuitry. The electrical substrate may also be mounted on an adhesive substrate 8 (FIG. 3) that facilitates the connection of the LED String to the support element. The LED String may also be encased in a transparent substrate to provide a weather and moisture barrier to extend the service life of the LED. The LED String may also be mounted onto a housing piece that facilitates the connection between the LED String and the support element. The LED String may also have notches or holes in the Sting that facilitates the connection to the support member.

The invention allows for easy retrofitting of light cabinets without an extra trip to the site to measure the dimensions of the lamp to be replaced or the installation of additional support brackets to install the replacement support structure. When replacing an existing lamp the service electrician can simply keep stock lengths of the invention on his truck, cut the stock pieces to the needed length of the lamp that is being replaced, affix the needed length of LED String to the external face or external faces of the invention as needed, install the invention, wire the LED string to the power source and installation is complete. Sometimes the lamp sockets 9 (FIGS. 5, 6, and 7) are not all installed with the same orientation. In previous light fixtures with cylindrical florescent lamps 14 (FIG. 7) this was not a problem as the light radiated the full 360 degrees from the florescent lamp so however the lamp sockets are oriented the cylindrical florescent lamp will light the sign faces of the light cabinet 12 (FIG. 7). In the current state of the art if the lamp sockets 9 (FIGS. 5, 6 and 7) are not properly oriented then the sign faces 13 (FIG. 7) will not receive maximum illumination of the light cabinet 12 (FIG. 7) because the LED lamp orientation will not be aligned to provide maximum illumination of the sign faces of the light cabinet. Since the present invention has a terminal end with a square cross section the invention can be installed oriented either way into the lamp socket for a proper lamp orientation to provide maximum illumination of the sign faces of the light cabinet.

The structural element is comprised of two terminal ends 2a, 2b (FIGS. 1, 4, and 6) and an elongate solid or hollow body portion 1 (FIG. 1, 4, 6) between the two terminal ends. The elongate body portion has multiple exterior faces 15 (FIGS. 1, 4 and 6) upon which a LED String 4 (FIG. 2) can be affixed or connected. An external face of the support element can be either a flat external face of the support element or be the external side of the support element in the case of a structural element with a circular cross section.

The invention is made by determining the appropriate dimensions of the needed elongate body length of the invention and size of the terminal ends of the structural element so that they may fit, without modification, directly into the existing light fixture 12 (FIG. 7) lamp sockets 9 (FIGS. 5 and 7). Once the light fixture lamp socket dimensions have been determined then the terminal ends of the structural element can be designed to fit into the light fixture lamp socket. The light fixture lamp socket dimensions may determine the height and depth of the terminal ends of the support element but the elongate body of the structural element may be of larger or smaller dimensions as is structurally required. Once the structural element is sized then one or more LED Strings 4 (FIGS. 2 and 4) are affixed to the external faces 15 (FIGS. 1, 4 and 6) of the structural element. After affixing or connecting the LED String or Strings to the external face, or faces, of the support element elongate body then a transparent plastic sleeve may be installed over the entire length of the support element and LED Strings to provide a standalone or additional weather and moisture barrier. This transparent sleeve moisture barrier may be made of a heat shrinkable material. Furthermore, silicone, hot melt copolymer, epoxy, or other sealant may be injected inside the ends of the transparent sleeve to provide additional moisture resistance.

The preferred embodiment of the apparatus is an elongate extrusion 1 (FIGS. 1, 4, 6 and 7) that is designed with terminal end 2a, 2b (FIGS. 1, 4 and 6) dimensions that fit securely into widely used existing T-12 sockets 9 (FIGS. 5, 6 and 7) of a light cabinet 12 (FIG. 7). The structural element has an elongate body with a square cross section and a hollow core 3 (FIGS. 1, 3 and 6). The elongate body of the support element has the same cross section dimensions as those of the terminal ends, being a square cross section. The T-12 lamp sockets have a recessed rectangular hole 10 (FIGS. 5 and 6) that has a protruding contact piece 11 (FIG. 5 and 6) within the recessed hole of the lamp socket 9 (FIGS. 5, 6 and 7). The structural element 1 (FIG. 6) is installed by pushing the terminal end 2a, 2b (FIG. 6) into the recessed opening 10 (FIG. 6) of the lamp socket 9 (FIG. 6) and the protruding contact 11 (FIGS. 5 and 6) fits snuggly within the hollow terminal end opening 3 (FIG. 6) of the structural element.

The length of the invention is determined by the length of the florescent lamps 14 (FIG. 7) that are being replaced. Once the structural element has been extruded and cut to size for length then a LED String, or LED Strings, are affixed to the external face or faces 15 (FIGS. 1, 4 and 6) of the structural element as needed. The LED String 4 (FIG. 2) contains one or more LED 6 (FIGS. 2 and 3) mounted on a flexible substrate 5 (FIGS. 2 and 3) that contains and encloses all the needed circuitry within the flexible substrate, the flexible substrate has the LED on one external face of the flexible substrate and an adhesive tape 8 (FIG. 3) on the opposite external face of the flexible substrate. This adhesive tape facilitates the connection between the LED String and the structural element. After connecting the LED Strings to the structural element as needed a transparent heat shrinking sleeve is pulled over the elongate body of the structural element covering the entire body of the structural element and LED String. A commercial sealant is then added to one or both ends of the transparent sleeve between the sleeve and the structural element providing a moisture resistant barrier between the transparent sleeve and the structural element, particular care should be taken in applying the sealant when wiring 7 (FIGS. 2, 3 and 4) from LED String to the power source exit from within the transparent sleeve. If the LED String 4 (FIGS. 2 and 4) external wiring 7 (FIGS. 2, 3 and 4) to the power source does not enter through the end of the transparent sleeve but rather enters the transparent sleeve between the two ends of the transparent sleeve then sealant should be applied where the external wiring enters the transparent sleeve. After the sealant has been applied between the transparent sleeve and the support element then heat is applied to the transparent sleeve so that the sleeve provides a tight fit around the LED Strings and the structural element.

### BACKGROUND OF INVENTION

Many lighting applications use fragile fluorescent lamps or another type of lamp that may be replaced with Light Emitting Diodes (“LED”) to increase energy efficiency and increase the service life of the lamp. Replacement of historical lamp types with LEDs is not a novel practice and has been occurring for the past decade or more. The novelty in this field of art is the invention of a structural arrangement that facilitates the use of LEDs for illumination in existing light fixtures. This has been accomplished for several lighting applications. U.S. Pat. No. 6,036,336 claims an invention that facilitates the use of LEDs in the retrofitting of existing illuminated traffic signals. Other companies have invented a structure that facilitates the replacement of incandescent bulbs with LEDs while using the same unmodified light fixture. The invention is directed to a structural arrangement for the replacement of fluorescent lamps, gas discharge lamps, and other lamp types that are supported at two terminal ends of the lamp. This type of lighting is widely used in signs, including backlit signs and cabinet signs, and other applications where illumination is necessary. This has been addressed by the prior art in the following patents and published applications.

In U.S. Pat. No. 8,474,998 the invention disclosed is a structural mounting system that facilitates the use of LEDs in the replacement of historical lamp types and specifically fluorescent lamps. This invention has an inner frame that makes a connection with the LED modules and two holding bases that are connected to the opposite ends of the inner frame of the light fixture or lighting cabinet. These holding bases are mechanically attached to the existing raceway structure of the existing light fixture. With these holding bases installed on the existing raceway the inner frame can be installed and the LED modules can serve as replacements for the previous fluorescent lamps. The drawback of this design is the need for installation of the holding bases in the existing light fixture which requires modification of the existing light fixture to accommodate the LED replacement.

In Published US Patent Application US 2012/0124874 A1 the invention disclosed is another structural mounting system that facilitates the replacement of previous lamp types with LEDs, specifically the replacement of fluorescent lamps. The invention disclosed includes an I-beam as the inner structural component which also has two opposite ends with specially designed end caps that are connected to each of the opposite ends of the I-beam. These end caps are designed so that the outward face of the end caps will fit into the existing lamp sockets of the fixture. The end caps in this application are designed to fit inside the existing lamp sockets with a protruding rectangular piece that fits into the recessed lamp socket. The replacement LEDs or other lamp types are connected to the web of the I-Beam. If the lamp sockets are not all installed with the same orientation then invention may not direct the illumination in the proper direction to provide maximum illumination on the sign face. This would require the removal and reinstallation of the lamp sockets. This invention eliminates the need for modifications to the light fixture by using the existing lamp sockets as mechanical supports for the new LED lamps, but may not function properly unless all of the lamp sockets are properly oriented.

The current invention eliminates the need for modification of the existing light fixture, the need for end caps to connect to the existing lamp sockets, and functions properly regardless of the orientation of the lamp sockets. The invention does this by a single structural element that has two terminal ends that are designed to fit directly into the existing lamp sockets without an end cap on the structural element or modification to the light fixture. The LEDs affixed to the exterior faces of the structural element provide illumination. The utility of the improvement over the prior art is that the invention will be easier and faster to install when replacing existing lamps with new LED lamps. This is because many of the lighting applications to be retrofitted are elevated from the ground surface which makes it more difficult to hoist a cumbersome replacement structure that comes in multiple pieces. Additionally, if the lamp sockets are not oriented properly then the invention can be installed without regard to the orientation of the lamp socket and still provide maximum illumination on the sign face distinguishing the invention from the prior art. With the current invention the lite weight and single piece construction of the invention makes installation of the invention into the existing light fixture quicker and easier than previous inventions addressing this problem.

### SUMMARY OF THE INVENTION

The invention is a structural element that has terminal ends designed to mechanically connect with new or existing light sockets. Light Emitting Diodes (“LED”) are affixed to the external faces of the structural element. The LEDs may be individually affixed to the external face of the support element or the LEDs may be mounted on a substrate that has all of the needed circuitry embedded within the substrate and this substrate may be affixed to the external face of the support element. The structural element is designed and manufactured so that it fits into existing lamp sockets that are designed to accommodate fluorescent lamps or another type of lamp that is supported at two terminal ends. The purpose of the invention is to allow the replacement of previous lamp types with LEDs to provide illumination at a reduced cost and extended service life.

The invention is manufactured starting with a structural element that can be cut to any length desired, and bent or molded into a specific shape to fit a particular application. After the support element is shaped then a singular or plurality of LEDs are affixed to the external faces of the support element. The LEDs can be arranged on an electrical substrate that has all of the needed circuitry embedded within the electrical substrate. This electrical substrate with LEDs is then affixed to the external faces of the structural element. The electrical substrate has contact points that are connected with a power source to illuminate the LEDs. After affixing the electrical substrate with LEDs to the structural element a transparent weather protective sleeve is pulled over the structural element and LEDs to provide a weather proofing barrier. This transparent weather proofing sleeve may be made out of a heat shrinking material. After the transparent sleeve is attached a sealant is applied to the each of the terminal ends of the transparent sleeve to inhibit the movement of moisture within the transparent sleeve.

Many illuminated signs use fluorescent bulbs or a double contact gas discharge lamp to illuminate the interior of a light cabinet and thus illuminate the sign. It is desirable to replace the fluorescent or other lamp type in service with an LED lamp. This lamp replacement with LEDs will provide a longer service life and reduced operating costs. Since lighted cabinet signs are ubiquitous it is desired to replace the lamp type but to use the existing light fixture and avoid the cost of replacing the light fixture. The invention provides for a method of retrofitting existing lighted signs that use fluorescent lamps with recessed T-12 sockets. The steps in the method are: the invention is sized and shaped to the desired dimensions, assembled with LEDs and needed circuitry to the external faces of the support element, and mechanically connected to the existing T-12 sockets. The LEDs are independently connected to the power source and the connection between the power source and the existing lamp sockets is disconnected. Once the wiring is complete the invention will provide replacement illumination.

### DESCRIPTION OF THE DRAWINGS

FIG. 1 is a perspective view of the elongate support element;

FIG. 2 is a top view of the LED String;

FIG. 3 is a side view of the LED String;

FIG. 4 is a perspective of the elongate support member with LED String attached on two exterior faces of the support element;

FIG. 5 is perspective view of a T-12 lamp socket;

FIG.6 depicts how the invention is installed between two opposing lamp sockets;

FIG. 7 depicts a light cabinet with the invention installed in the opposing lamp sockets.

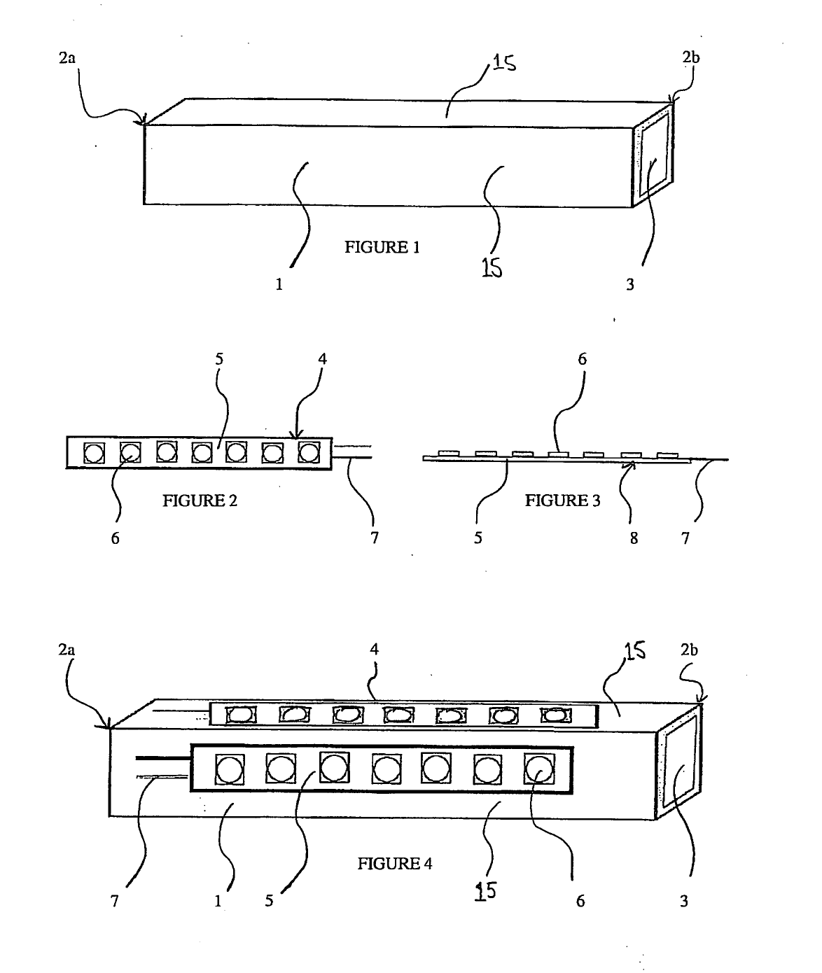

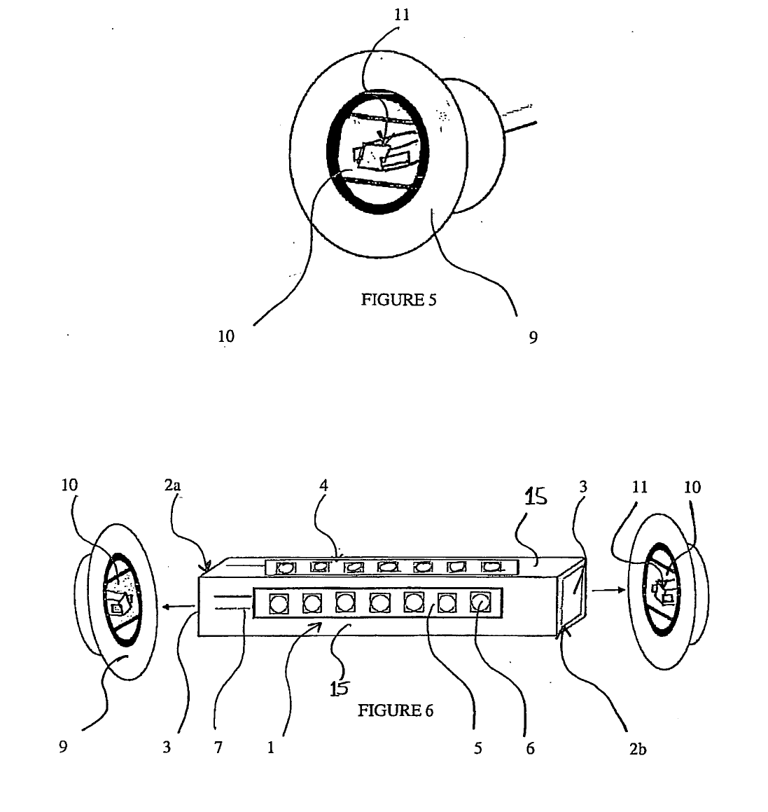

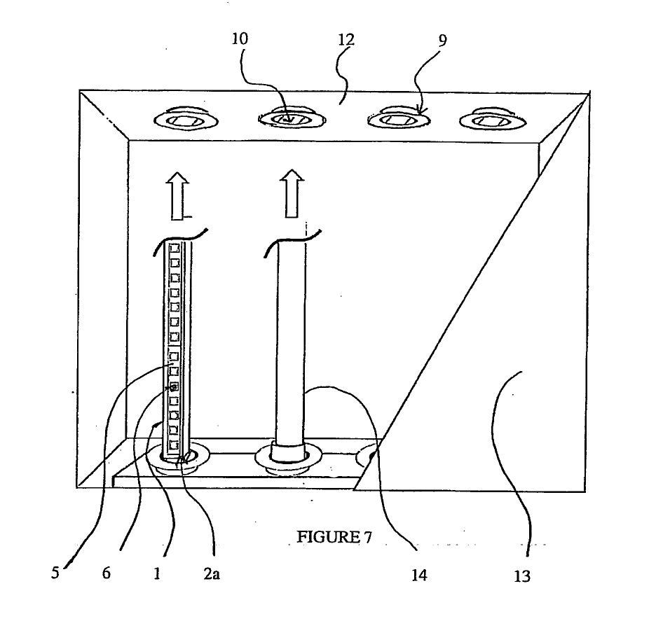

1. An apparatus of a single structural element that is comprised of two terminal ends, each end is designed to mechanically connect with a lamp socket to support the structural element, and LED String or LED Strings are connected to the external faces of the structural element to provide illumination.

2. An apparatus according to claim one where the terminal ends of the support element are designed to fit within recessed double contact fluorescent sockets.

3. An apparatus according to claim one where the support element has a hollow square cross section.

4. An apparatus according to claim one where the support element has a circular cross section.

5. An apparatus according to claim one where the linear element has a rectangular cross section.

6. An apparatus according to claim one where all of the LED Strings are encapsulated within transparent plastic sleeve.

7. An apparatus according to claim one where the LED Strings are encapsulated within a transparent sleeve and the support element and the LED Strings with transparent sleeve are encapsulated within a second heat shrinking transparent sleeve.

8. A manufacture of a single structural element that is comprised of two terminal ends, each terminal end is designed to mechanically connect with a lamp socket and the external faces of support element have LED String or LED Strings connected to external faces

9. A manufacture according to claim eight where the ends of the structural element are designed to fit within recessed double contact fluorescent sockets.

10. A manufacture according to claim eight where the structural element has a square cross section.

11. A manufacture according to claim eight where the structural element has a circular cross section.

12. A manufacture according to claim eight where the structural element has a rectangular cross section.

13. A manufacture according to claim eight where all of the LED Strings and structural element are encapsulated within transparent heat shrinking material.

14. A method of retrofitting a light cabinet with a single structural element with terminal ends designed to connect with existing lamp sockets and the support element has LED String or LED Strings connected to the external faces of the structural element.
